(19) United States
(12) Patent Application Publication
(10) Pub. No.: US 2005/0175902 A1
(43) Pub. Date: Aug. 11, 2005

(54) Lithium polymer battery cell

(76) Inventor: Mohammad Parsian, Swartz Creek, MI (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/776,065

(22) Filed: Feb. 11, 2004

(51) Int. Cl. H01M 4/72; H01M 4/66

(52) U.S. Cl. 429/241; 429/233; 429/245; 429/128

(57) ABSTRACT

A lithium polymer battery cell configured with at least one anode and at least one cathode, each including a current collector, one of which is a metal foil and the other of which is a metal grid. The cell may be a unicell, bicell, multicell or a multibicell. In one example, the cell may include one or more anodes having a copper grid current collector and one or more cathodes having an aluminum foil current collector, and in another example, the cell may include one or more anodes having a copper foil current collector and one or more cathodes having an aluminum grid current collector.

### TECHNICAL FIELD

This invention relates to laminate configurations for lithium cells, in particular lithium ion and lithium ion polymer battery cells.

### BACKGROUND OF THE INVENTION

Lithium ion cells and batteries are secondary (i.e., rechargeable) energy storage devices well known in the art. The lithium ion cell, known also as a rocking chair type lithium ion battery, typically comprises essentially a carbonaceous anode (negative electrode) that is capable of intercalating lithium ions, a lithium-retentive cathode (positive electrode) that is also capable of intercalating lithium ions, and a non-aqueous, lithium ion conducting electrolyte therebetween.

The carbon anode comprises any of the various types of carbon (e.g., graphite, coke, carbon fiber, etc.) which are capable of reversibly storing lithium species, and which are bonded to an electrochemically conductive current collector (e.g. copper foil or grid) by means of a suitable organic binder (e.g., polyvinylidene fluoride, PVdF).

The cathode comprises such materials as transition metal chalcogenides that are bonded to an electrochemically conductive current collector (e.g., aluminum foil or grid) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂, LiNiO₂, and LiFePO4, their solid solutions and/or their combination with other metal oxides and dopant elements, e.g., titanium, magnesium, aluminum, boron, etc.

The electrolyte in such lithium ion cells comprises a lithium salt dissolved in a non-aqueous solvent which may be (1) completely liquid, (2) an immobilized liquid (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyvinylidene fluoride, polyolefins such as polypropylene and polyethylene, and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer.

During processing of the cell precursor, a large quantity of a homogeneously distributed plasticizer is present in the solid polymeric matrix in order to create porosity. For example, the plasticizer may be propylene carbonate, phthalic acid diesters, adipic acid diesters, acetic acid esters, organic phosphates, and/or trimellitic acid triesters. These plasticizers must be removed before the cell is activated with an electrolyte because, if mixed with the electrolyte, the plasticizers can damage the cell. The plasticizers are generally removed by extracting them into a solvent, such as diethyl ether or hexane, which selectively extract the plasticizer without significantly affecting the polymer matrix. This produces a “dry” electrolytic cell precursor, in that the precursor does not contain any electrolyte solvent or salt. An electrolyte solvent and electrolyte salt solution is then imbibed into the “dry” electrolytic cell copolymer membrane structure to yield a finctional electrolytic cell system. The ion-conducting electrolyte provides ion transfer from one electrode to the other, and commonly permeates the porous structure of each of the electrodes and the separator.

Lithium and lithium ion polymer cells are often made by adhering, e.g., by laminating, thin films of the anode, cathode and/or electrolyte/separator together. Each of these components is individually prepared, for example, by coating, extruding, or otherwise, from compositions including one or more binder materials and a plasticizer. The electrolyte/separator is adhered to an electrode (anode or cathode) to form a subassembly, or is adheringly sandwiched between the anode and cathode layers to form an individual cell or unicell. A second electrolyte/separator and a second corresponding electrode may be adhered to form a bicell of, sequentially, a first counter electrode, a film separator, a central electrode, a film separator, and a second counter electrode. A number of cells are adhered and bundled together to form a high energy/voltage battery or multicell.

In constructing a lithium-ion cell, an anodic current collector may be positioned adjacent a single anode film, or sandwiched between two separate anode films, to form the negative electrode. Similarly, a cathodic current collector may be positioned adjacent a single cathode film, or sandwiched between two separate cathode films, to form the positive electrode. A separator is positioned between the negative electrode and the positive electrode. The anode, separator, and cathode structures are then adhered together (e.g., by laminating) to produce a unitary flexible electrolytic cell precursor.

While the current collectors may be made of foil or grids, grids have been the preferred current collector material because the extracting solvent and the battery electrolyte cannot penetrate the foil material. Thus, the open structure of the grids allow for easier extraction of the plasticizer from the electrode films and good absorption of the electrolyte. However, the electrodes cannot be directly cast onto the open structure materials, such that the electrode layers must be first cast onto a temporary substrate, such as mylar sheet, and then laminated to the current collector grid. The grid material itself is also more complicated to manufacture than a foil, since the grid first involves forming a sheet material and then perforating the sheet material and expanding it to form the open structure. This highly labor-intensive process results in a higher cost for the grid material. Currently, aluminum and copper grids cost approximately 90% more than aluminum and copper foil.

It is desirable to develop a cell configuration that enables removal of the plasticizer from the electrode films and good absorption of the electrolyte, while reducing the material costs for the current collectors and for the electrode formation.

### SUMMARY OF THE INVENTION

The present invention provides a lithium polymer battery cell comprising a first electrode, a second electrode of opposite charge from the first electrode, and a separator between the first and second electrodes. The first electrode comprises at least one first electrode layer adjacent a first current collector, and the second electrode comprises at least one second electrode layer adjacent a second current collector. In accordance with the present invention, one of the first and second current collectors is a metal grid and the other is a metal foil. The cell may be configured as a unicell, bicell, multicell or a multibicell. The battery cell may include two-layer electrodes having the current collector positioned at an outer surface of the electrode, or three-layer electrodes having the current collector sandwiched between electrode layers or films having the same charge, or a combination of two- and three-layer electrodes.

The present invention also provides a lithium polymer battery comprising at least one cell with a first electrode, a second electrode of opposite charge from the first electrode, and a separator between the first and second electrodes, wherein the battery is in a folded or corrugated configuration. In the corrugated configuration the first electrode is the exterior of a folded cell and is configured continuously, and the second electrode is the interior electrode of a folded cell and is advantageously configured discontinuously. Advantageously, the interior electrode includes the metal foil current collector.

According to one exemplary embodiment of the present invention, the battery cell includes a bicell comprising a pair of anodes each with a copper grid current collector adjacent at least one anode layer, and a cathode sandwiched between the pair of anodes, wherein the cathode is comprised of an aluminum foil current collector sandwiched between a pair of cathode layers. A separator layer is positioned between the cathode and each of the pair of anodes. According to another exemplary embodiment of the present invention, the battery cell includes a bicell comprising a pair of cathodes with each having an aluminum grid current collector adjacent at least one cathode layer and an anode sandwiched between the pair of cathodes and having a copper foil current collector sandwiched between a pair of anode layers. A separator layer is positioned between the anode and each of the pair of cathodes. In each of the exemplary bicell embodiments, the pair of electrodes may be configured discontinuously in the bicell in a folded configuration to form a corrugated multibicell.

There is thus provided a lithium cell that provides good processing and performance efficiency, and that may be manufactured with greater productivity and decreased costs.

### BRIEF DESCRIPTION OF THE DRAWINGS

The present invention will now be described, by way of example, with reference to the accompanying drawings, in which:

FIG. 1A is a schematic top view of a battery unicell in accordance with one embodiment of the present invention having a two layer continuous anode with an external anodic current collector grid and a two layer continuous cathode with an external cathodic current collector foil;

FIG. 1B is a schematic top view of the unicell of FIG. 1A in a rolled configuration with the continuous cathode positioned at the interior of the unicell;

FIG. 2A is a schematic top view of a battery multicell in accordance with one embodiment of the present invention having a two layer continuous cathode with an external cathodic current collector foil and a two layer discontinuous anode with an external anodic current collector grid;

FIG. 2B is a schematic top view of the multicell of FIG. 2A in a folded configuration with a discontinuous anode positioned at the interior of the multicell;

FIG. 3A is a schematic top view of a battery multicell in accordance with one embodiment of the present invention having a three layer continuous anode with a buried anodic current collector foil and a three layer discontinuous cathode with a buried cathodic current collector grid;

FIG. 3B is a schematic top view of the multicell of FIG. 3A in a folded configuration with the discontinuous cathode positioned at the interior of the multicell;

FIG. 4A is a schematic top view of a battery multicell in accordance with one embodiment of the present invention having a three layer continuous cathode with a buried cathodic current collector grid and a three layer discontinuous anode with a buried anodic current collector foil;

FIG. 4B is a schematic top view of the multicell of FIG. 4A in a folded configuration with a discontinuous anode positioned at the interior of the multicell;

FIG. 5A is a schematic top view of a battery bicell in accordance with one embodiment of the present invention having a pair of two layer continuous anodes with an external anodic current collector foil and a three layer continuous cathode with a buried cathodic current collector grid;

FIG. 5B is a schematic top view of the multibicell of FIG. 5A in a rolled configuration;

FIG. 6A is a schematic top view of a battery multibicell in accordance with one embodiment of the present invention having a pair of two layer discontinuous cathodes with an external cathodic current collector grid and a three layer continuous anode with a buried anodic current collector foil;

FIG. 6B is a schematic top view of the multibicell of FIG. 6B in a folded configuration;

FIG. 7A is a schematic top view of a battery multibicell in accordance with one embodiment of the present invention having a pair of three layer discontinuous anodes with a buried anodic current collector grid and a three layer continuous cathode with a buried cathodic current collector foil;

FIG. 7B is a schematic top view of the multibicell of FIG. 7A in a folded configuration;

FIG. 8A is a schematic top view of a battery multibicell in accordance with one embodiment of the present invention having a pair of three layer discontinuous cathodes with a buried cathodic current collector foil and a three layer continuous anode with a buried anodic current collector grid; and

FIG. 8B is a schematic top view of the multibicell of FIG. 8A in a folded configuration.

### DETAILED DESCRIPTION

A battery cell of the present invention has two opposite electrodes, an anode (negative electrode) and cathode (positive electrode), with a separator between them. Each electrode (the anode and/or the cathode) may comprise two or more electrode layers that are separated by a current collector. For example, an anode may be comprised of two negative electrode layers separated by a negative current collector, and/or the cathode may be comprised of two positive electrode layers separated by a positive current collector. Alternatively, each electrode (the anode and/or the cathode) may comprise a single electrode layer and a current collector positioned external to the battery cell. The plane of the current collector is generally parallel to the plane of the polymer matrix film portion of the electrode. Similarly, the plane of separator films is generally parallel to the plane of the electrodes. In accordance with the present invention, one electrode comprises a metal grid current collector and the other electrode comprises a metal film current collector. For example, the battery cell may include a cathode having an aluminum grid current collector and an anode having a copper foil current collector. Alternatively, a battery cell may comprise a cathode with an aluminum foil current collector and an anode with a copper grid current collector. The term “grid” as used herein generically refers to any type of open-structure material, including, for example, grids, meshes and sheet material with holes or slits positioned periodically throughout.

The electrodes may be formed by direct casting, extrusion, and/or lamination methods. The electrode that includes the metal grid current collector, however, may not be formed by direct casting of the electrode layer to the current collector. Rather, the electrode layer may be directly cast onto a temporary substrate, such as a mylar film, and subsequently separated from the temporary substrate and laminated to the metal grid. On the other hand, the electrode comprising the metal film current collector may be formed by directly casting the electrode layer onto the metal film. The metal film current collector has a raw material cost about 90% lower than that of the metal grid current collector. Thus, the electrode comprising the metal film current collector may be fabricated at a lower cost and using a method that eliminates the steps of removing the electrode layer from a temporary substrate and laminating the electrode layer to the current collector, thereby reducing time and labor associated with forming the electrode. In accordance with the present invention, one electrode may thus be formed at a lower cost using less time and labor, while the other electrode maintains the efficient removal of plasticizer from the electrode film and good absorption of the battery electrolyte.

After formation of the electrodes, the electrodes and separator are adhered to form a cell. As known to one skilled in the art, adherence may be accomplished by laminating using pressure (manual and/or mechanical), heat, or a combination of pressure and heat. When the components are adhered or laminated, there is a series of generally planar laminated elements. In one exemplary embodiment, the battery cell may be folded one or more times, with a resulting corrugated structure, or the battery cell may be rolled up.

Advantageously, to configure a corrugated or rolled battery cell, one electrode is continuous, while the other electrode is discontinuous, as described more fully in commonly owned and copending U.S. application Ser. No. 10/348,749 filed Jan. 22, 2003, incorporated by reference herein in its entirety. More specifically, the electrode that will be the outermost electrode of the final cell, either the anode or the cathode, is configured as continuous. The opposite electrode is configured as discontinuous. For example, a cell designed with a discontinuous inner negative electrode will have a continuous outer positive electrode, and a cell designed with a discontinuous inner positive electrode will have a continuous outer negative electrode. As used herein, discontinuous is defined as an anode or cathode in which the charge of that electrode, either positive or negative, is carried by a plurality of joined electrodes or multiple joined electrodes, rather than by a single electrode. Thus, as used herein, multiple electrodes refer to discontinuous electrodes or components, and a single electrode refers to a continuous electrode. In a further exemplary embodiment, the inner electrode in a corrugated or rolled battery cell includes the metal foil current collector.

The number of discontinuous electrodes or components making up the inner electrode depends upon the parameters desired in the resulting cell (e.g., size, power, efficiency), as determined by one skilled in the art. The cell configurations, and methods for producing these cell configurations, allow for increased flexibility in battery design. The cell configurations can be used to produce a battery of any size or capacity, for example, a multibicell battery, a multicell battery, a battery having multiple modules that each have multiple multicells or multibicells, etc.

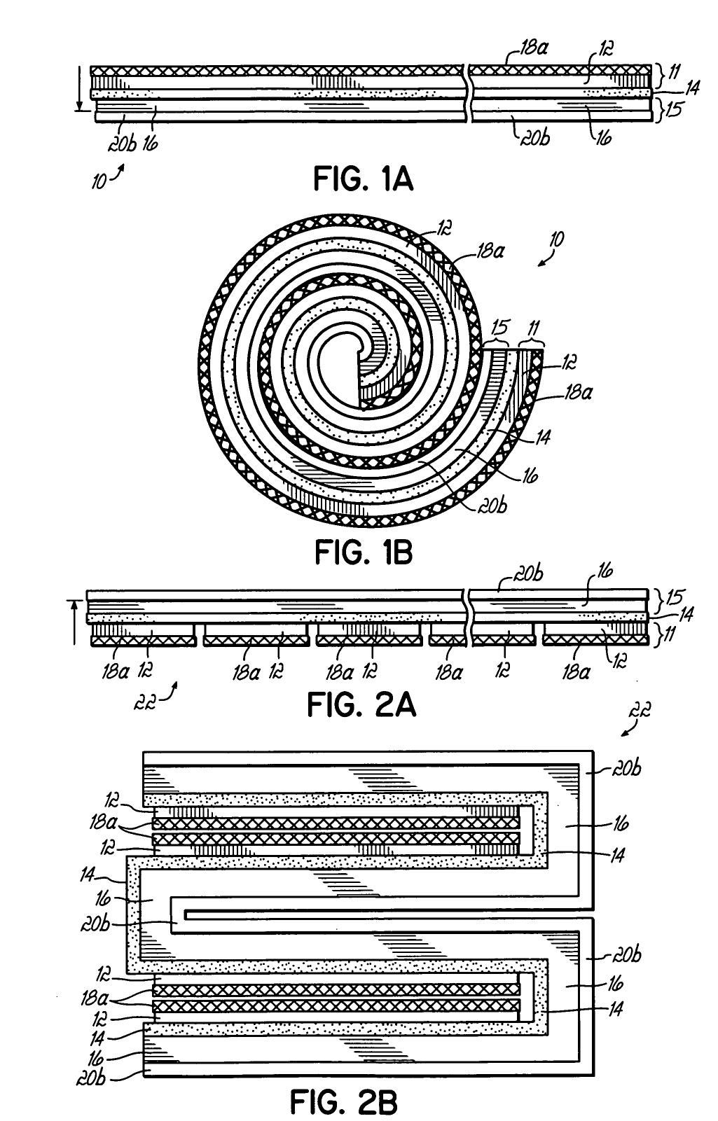

In one embodiment of the present invention, depicted schematically in a top view in FIGS. 1A and 1B, the battery cell is a unicell 10 having a continuous (single) anode 11 (negative electrode) configured as the outermost electrode in a rolled cell 10 shown in FIG. 1B, a separator 14, and a continuous (single) cathode 15 (positive electrode) configured as an inner electrode in the rolled cell 10. That is, a separator 14 separates a single anode 11 from a single cathode 15. A single negative (anodic) current collector grid 18a (copper grid) is positioned external to an anode layer 12 throughout the entire geometry, to form the single two-layer anode 11. A single positive (cathodic) current collector foil 20b (aluminum foil) is positioned external to a cathode layer 16 throughout the entire geometry, to form the single two-layer cathode 15. As indicated by the arrow in FIG. 1A, solvent and electrolyte flow is permitted through the anodic current collector grid 18a continuously until reaching the cathodic current collector foil 20b.

FIG. 2A depicts a multicell 22 having a discontinuous (multiple) anode 11 and a continuous (single) cathode 15, each with external current collectors 18a, 20b, respectively, that parallel those shown in FIGS. 1A and 1B, respectively, except in reverse, such that the cathode 15 is the external electrode and anode 11 is the inner electrode in a rolled or corrugated configuration. In this embodiment, the battery cell 22 includes a single cathode (positive electrode) with a positive current collector foil 20b located external to a single cathode layer 16, a separator 14, and multiple anodes 11 (negative electrodes) with a negative current collector grid 18a located external to each of the multiple anode layers 12. In the corrugated (folded or zig-zag) configuration of FIG. 2B, the multiple anodes 11 are configured so that the facing parallel surfaces of the separator layers 14 separate the continuously configured cathode 15 from two discontinuously configured anodes 11, and the two discontinuously configured anodes 11 with external current collector grids 18a are mirror images. The multiple anodes 11, being discontinuous, thus do not assume the zig-zag configuration, and are contained within the folds of the continuous cathode 15 so as to be the interior electrodes of the battery multicell 22. As depicted by the arrow in FIG. 2A, solvent and electrolyte flow may occur through the anodic current collector grid 18a and through the cell 22 until reaching the cathodic current collector foil 20b. While FIGS. 2A and 2B illustrate a multicell 22 having five anodes 11 (five unicells), multicells with two, three, or four anodes may be used, as well as multicells with greater than five anodes.

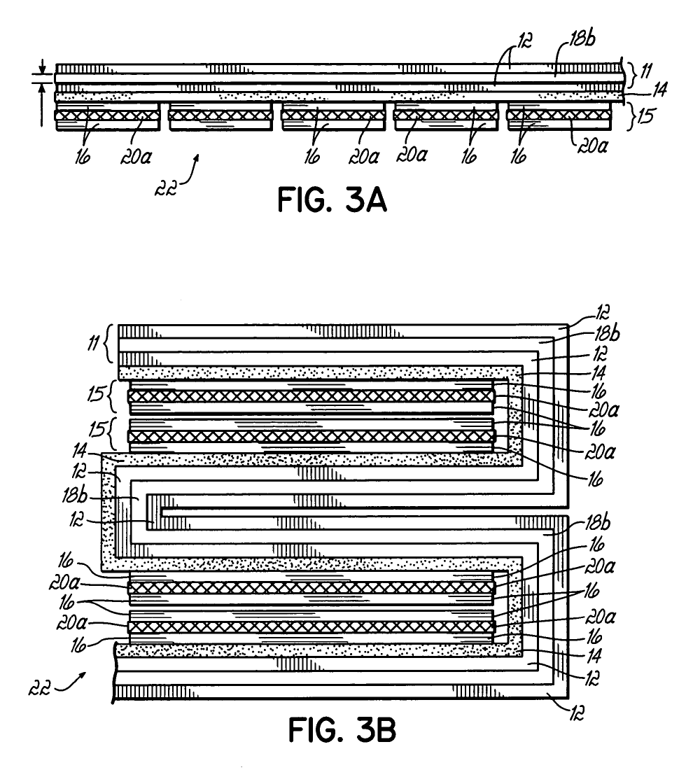

In another embodiment of the invention, shown in FIGS. 3A and 3B, a multicell 22 is depicted having a continuous anode 11 (negative electrode) configured as the exterior of the folded multicell 22 of FIG. 3B, a separator 14, and a discontinuous cathode 15 (positive electrode) configured in the interior or inner surface of the folded multicell 22. That is, a separator 14 separates a single anode 11 from multiple cathodes 15. The negative current collector foil 18b is sandwiched between two anode layers 12 thereby splitting the anode 11 into two electrode layers with the current collector foil embedded therebetween, and thus forming a three-layer anode 11. The positive current collector grids 20a are each sandwiched between two cathode layers 16 thereby splitting each cathode 15 into two electrode layers with the current collector grid embedded therebetween, and thus forming a plurality of three-layer cathodes 15.

In the corrugated (zig-zag or folded) configuration depicted in FIG. 3B, the single anode 11 with an embedded negative current collector foil 18b is located throughout the entire geometry. The multiple cathodes 15 are configured so that the parallel surfaces of the separator layer 14 separate the continuously configured anode 11 from two discontinuously configured cathodes 15, and the two discontinuously configured cathodes 15 with embedded current collector grids 20a are mirror images. The multiple cathodes 15, being discontinuous, thus do not assume the zig-zag configuration, and are contained within the folds of the continuous anode 11 so as to be the interior electrodes of the battery multicell 22. As depicted by the arrows in FIG. 3A, solvent and electrolyte flow may occur from the exteriors of the cell 22 in both directions until reaching the anodic current collector foil 18b.

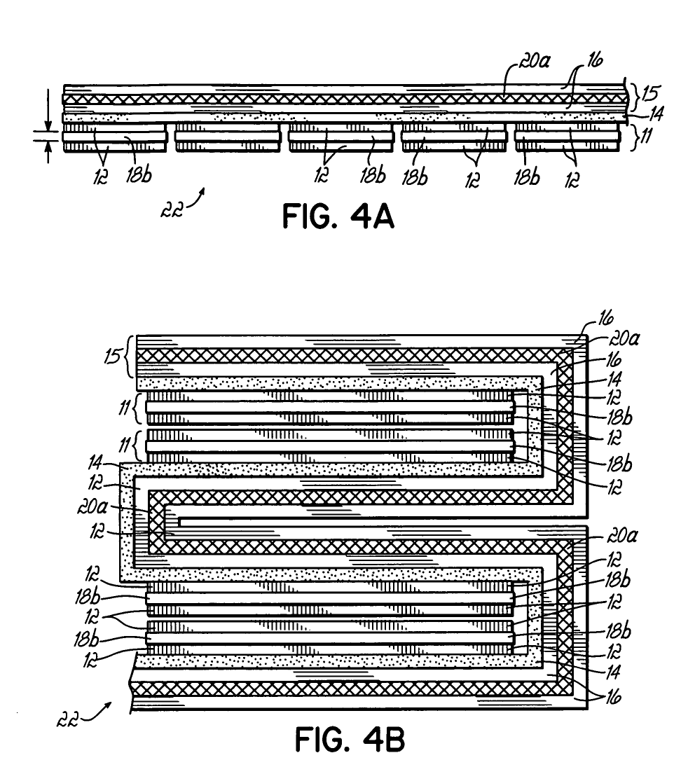

An alternative embodiment of the invention, shown in FIGS. 4A and 4B, is a multicell 22 design having a continuous (single) cathode 15 (positive electrode) configured as the exterior of the folded cell 10 shown in FIG. 4B, a separator 14, and a discontinuous (multiple) anode 11 (negative electrode) configured in the interior or inner surface of the folded cell 10. That is, a separator 14 separates a single cathode 15 from multiple anodes 11. The positive current collector grid 20a is sandwiched between two cathode layers 16 thereby splitting the cathode 15 into two electrode layers with the current collector grid embedded therebetween, and thus forming a single three-layer cathode 15. The negative current collector foils 18b are each sandwiched between two anode layers 12 thereby splitting each anode 11 into two electrode layers, with the current collector foil embedded therebetween, and thus forming multiple three-layer anodes 11.

The multicell depicted in FIG. 4A may be in a zig-zag or folded configuration, as shown in FIG. 4B in schematic top view. In this embodiment, there is a single cathode 15 with an embedded positive current collector grid 20a located throughout the entire geometry. The multiple anodes 11 are configured so that the parallel surfaces of the separator layer 14 separate the continuously configured cathode 15 from two discontinuously configured anodes 11, and the two discontinuously configured anodes 11 with embedded current collector foils 18b are mirror images. The multiple anodes 11, being discontinuous, thus do not assume the zig-zag configuration, and are contained within the folds of the continuous cathode 15 so as to be the interior electrodes of the battery multicell 22. As indicated by the arrows in FIG. 4A, solvent and electrolyte flow is permitted from the exteriors of the cell 22 continuously in both directions until reaching the current collector foil 18b in the anode 11.

FIGS. 1A-4B thus illustrate that the present invention is useful in numerous unicell and multicell configurations, wherein one of the anode or cathode includes a current collector foil, and the other of the anode and cathode includes a current collector grid. Another embodiment of the invention is a bicell or multibicell. In a bicell, components are adhered so that a pair of outer electrodes having the same charge sandwich one inner electrode having the opposite charge. In a multibicell, the pair of electrodes forming the outermost layers of the final cell may be configured discontinuously. In accordance with the present invention, the pair of outer electrodes include a current collector grid and the inner electrode includes a current collector foil, or vice-versa. Any or all of the electrodes may be two-layer or three-layer electrodes, as described above. For example, in a bicell having a cathode between a pair of anodes, each anode in the pair of anodes (negative electrodes) may have an external negative current collector adjacent a single anode layer, or may have a pair of anode layers sandwiching the current collector therebetween, thereby splitting each anode of the pair into two electrode layers. The cathode advantageously has a positive current collector sandwiched between a pair of cathode layers, thereby splitting the cathode into two electrode layers, but alternatively, the cathode may have a single cathode layer adjacent a current collector. For the same embodiment as a multibicell, the pair of anodes are in a discontinuous configuration. Each anode is separated from the cathode by a separator.

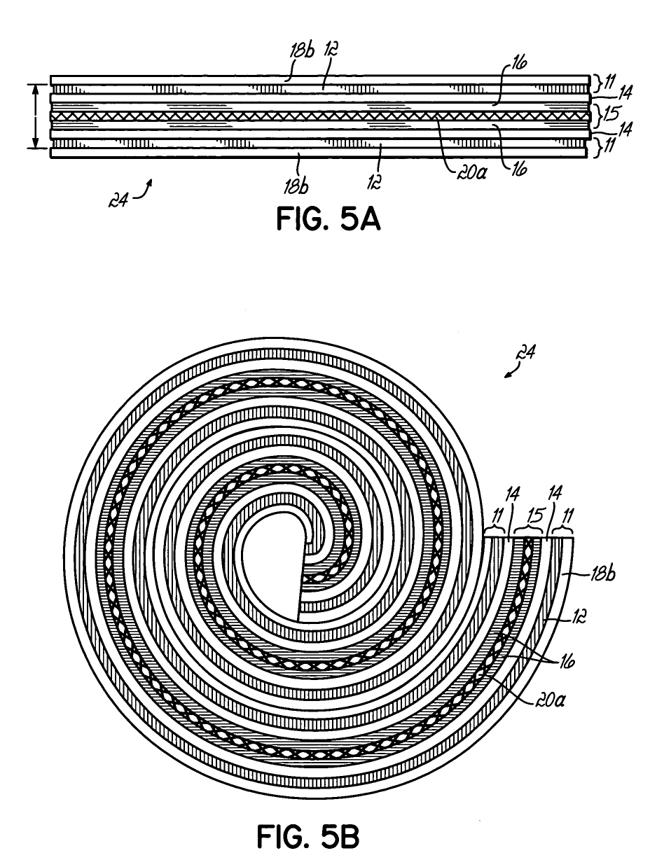

FIGS. 5A and 5B depict a bicell 24 design. A single cathode 15 (positive electrode) is configured in the interior of the rolled cell 10 shown in FIG. 5B, and the cathode 15 is a three-layer cathode having two cathode layers 16 embedding a positive current collector grid 20a. A pair of separators 14 separates each of the cathode layers 16 from a pair of continuous anodes 11 (negative electrodes). That is, one separator 14 separates one cathode layer 16 on one side from one continuous anode 11, and another separator 14 separates the other cathode layer 16 on the other side from the other continuous anode 11. Each anode 11 is a two-layer anode having an anode layer 12 and an external current collector foil 18b.

The bicell 24 depicted in FIG. 5B is in a rolled configuration. In this embodiment, there is a single inner cathode 15 with an embedded positive current collector grid 20a throughout the entire geometry. Negative current collector foils 18b are located external in each of the anodes 11, with one forming the outermost surface of the rolled cell 24, as shown in FIG. 5, and the other forming the innermost surface. As indicated by the arrows in FIG. 5A, solvent and electrolyte flow is permitted throughout the interior of the bicell 24 until reaching the exterior current collector foils 18b in the anodes 11.

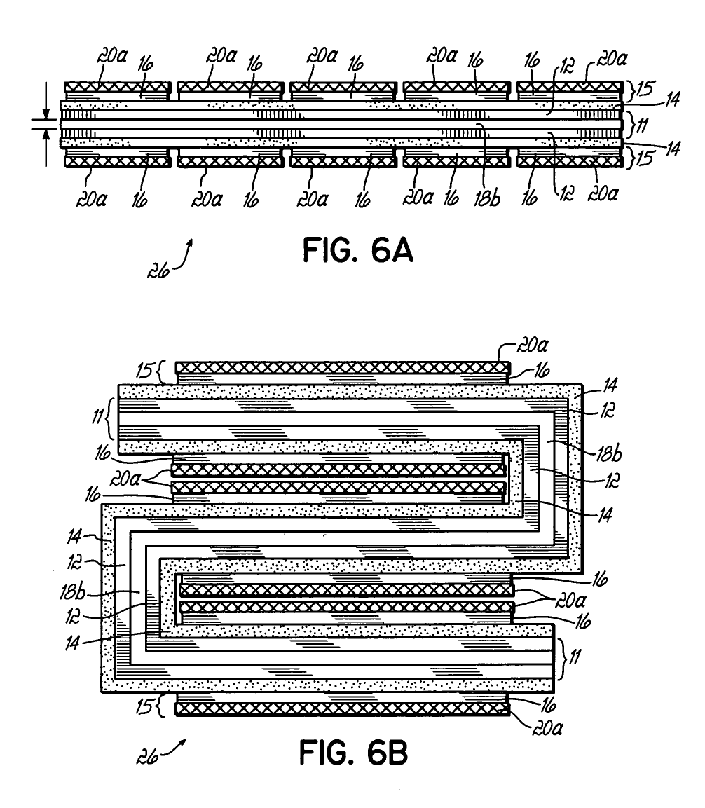

FIG. 6A depicts a multibicell 26 configuration that parallels that shown in FIG. 5A, except that the charges of the electrodes are reversed and the pair of outer electrodes are discontinuous. A single anode 11 (negative electrode) is configured in the interior of cell 10 shown in FIG. 6A and in the folded cell 10 shown in FIG. 6B, and the anode 11 is a three-layer electrode having two anode layers 12 sandwiching a negative current collector foil 18b. A pair of separators 14 separates each of the anode layers 12 from a pair of discontinuous cathodes 15 (positive electrodes). That is, one separator 14 separates one anode layer 12 on one side from one discontinuous cathode 15, and another separator 14 separates the other anode layer 12 on the other side from the other discontinuous cathode 15. Each cathode 15 is a two-layer cathode having a cathode layer 16 and an external current collector grid 20a. While FIG. 6A illustrates a multibicell 26 having five cathodes 15 (five bicells), multibicells with two, three, or four cathodes 15 may be used, as well as multibicells with greater than five cathodes 15.

The multibicell 26 depicted in FIG. 6A may be in a corrugated (zig-zag or folded) configuration, as shown schematically in top view in FIG. 6B. In this embodiment, there is a single inner anode 11 with an embedded negative current collector foil 18b throughout the entire geometry. The multiple cathodes 15 are configured so that each of the parallel surfaces of the separator layer 14 separate the continuously configured anode layers 12 from two discontinuously configured cathodes 15, and the two discontinuously configured cathodes 15 with external current collector grids 20a are mirror images. The cathodes 15, being discontinuous, thus do not assume the zig-zag configuration. Some of the cathodes 15 will form the outmost electrodes in the folded cell 26, while other cathodes 15 will be contained within the folds of the continuous anode 11 so as to be the innermost electrodes of the battery multibicell 26. As indicated by the arrows in FIG. 6A, solvent and electrolyte flow is permitted through the external positive current collectors grids 20a continuously until reaching the embedded current collector foil 18b in the inner anode 11.

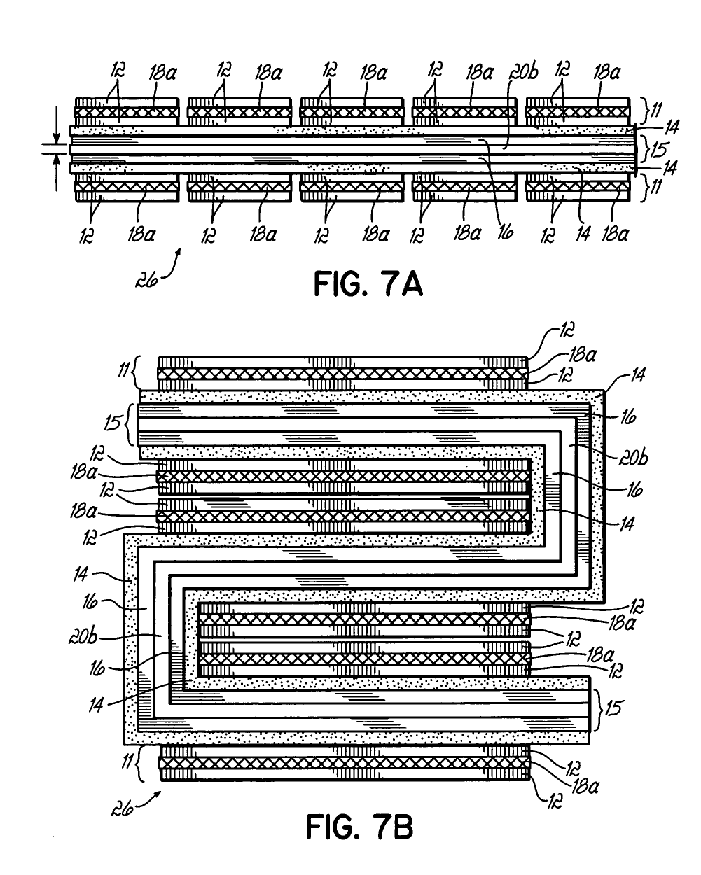

FIGS. 7A and 7B depict a multibicell 26 design having a single three-layer cathode 15 (positive electrode) configured in the interior of the cell 26 shown in FIG. 7A and in the folded cell 26 shown in FIG. 7B, a pair of separators 14, and a pair of discontinuous three-layer anodes 11 (negative electrodes) as the outermost electrodes. That is, one separator 14 separates one cathode layer 16 on one side from one discontinuous anode 11, and another separator 14 separates the other cathode layer 16 on the other side from the other discontinuous anode 11. While FIG. 7A illustrates a multibicell 26 having five anodes 11 (five bicells), multibicells with two, three, or four anodes may be used, as well as multibicells with greater than five anodes, as previously described.

In accordance with the present invention, a single positive current collector foil 20b is embedded between a pair of cathode layers 16. A plurality of negative current collector grids 18a are embedded between a plurality of pairs of anode layers 12.

The multibicell 26 depicted schematically in top view in FIG. 7B is in a corrugated (zig-zag or folded) configuration. In this embodiment, there is a single inner cathode 15 with an embedded positive current collector foil 20b located throughout the entire geometry. The multiple anodes 11 are configured so that each of the parallel surfaces of the separator layer 14 separate the continuously configured cathode layers 16 from two discontinuously configured anodes 11, and the two discontinuously configured anodes 11 with embedded current collector grids 18a are mirror images. The multiple anodes 11, being discontinuous, thus do not assume the zig-zag configuration. Some of the anodes 11 will form the outermost electrodes in the folded cell 26, while other anodes 11 will be contained within the folds of the continuous cathode 15 so as to be the innermost electrodes of the battery multibicell. As indicated by the arrows in FIG. 7A, solvent and electrolyte flow is permitted from the exteriors of the cell 26 through the negative current collector grids 18a and through the cell 26 continuously until reaching the embedded positive current collector foil 20a in inner cathode 15.

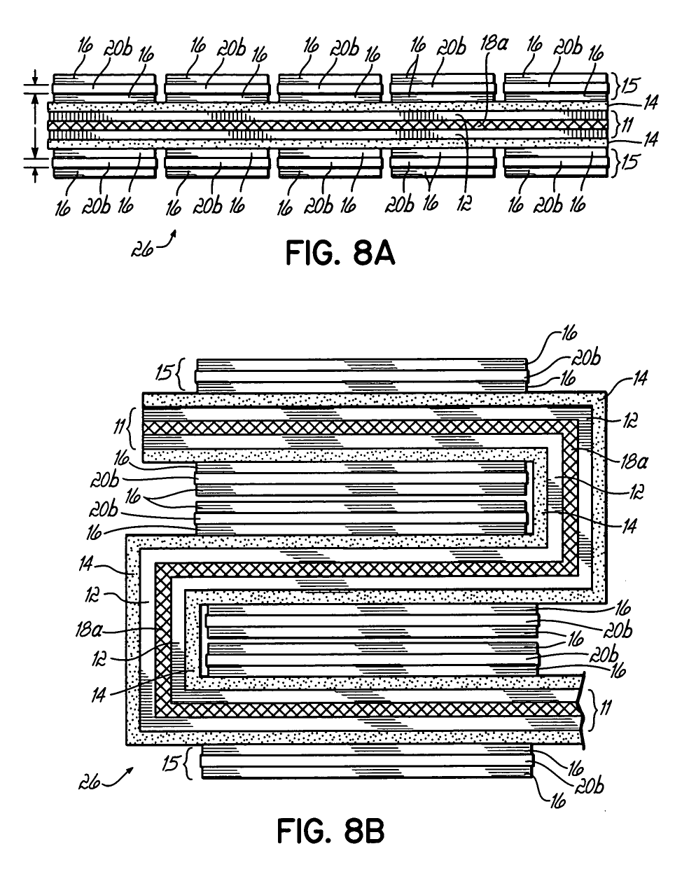

FIGS. 8A and 8B show a multibicell 26 configuration that parallels that shown in FIGS. 7A and 7B, except that the electrodes are reversed. FIG. 8A schematically shows two discontinuous cathodes 15 sandwiching a single continuous anode 11. The anode 11 is a three-layer electrode having a negative current collector grid 18a sandwiched between two anode layers 12, and the plurality of cathodes 15 are each a three-layer electrode having a positive current collector foil 20b sandwiched between two cathode layers 16. FIG. 8A depicts the multibicell 26 in a corrugated (zig-zag or folded) configuration. As indicated by the arrows in FIG. 8A, the continuous flow of solvent and electrolyte is permitted throughout the interior of the battery cell 26 and from the exteriors of the cell until reaching the positive current collector foils 20b embedded in discontinuous cathodes 15.

With a cell having a continuous first electrode and one or two continuous second electrodes of a charge opposite the first electrode, any of the following embodiments of a cell are possible: the cell may be a unicell (FIGS. 1A and 1B) or a bicell (FIGS. 5A and 5B). With a cell having a continuous first electrode and one or two discontinuous second electrodes of a charge opposite the first electrode, where either the anode is the continuous electrode and the cathode(s) are the discontinuous electrodes, or the cathode is the continuous electrode and the anode(s) are the discontinuous electrodes, any of the following embodiments of a cell are possible: the cell may be a multicell (FIGS. 2A-4B) or a multibicell (FIGS. 6A-8B). In either the unicell, bicell, multicell or multibicell embodiments, the cell may have a metal foil as the current collector for all anodes and a metal grid as the current collector for all cathodes, or the cell may have a metal foil as the current collector for all cathodes and a metal grid as the current collector for all anodes. The foil and/or grid current collectors may be positioned adjacent an electrode layer and external thereto, or may be embedded between two electrode layers. The use of a metal grid for one of the electrodes permits free flow of solvent and electrolyte therethrough to enable plasticizer removal and ion conduction. The use of a metal foil for the other electrode allows for a cost reduction associated with fabrication of the electrode, though the metal foil impedes the flow of solvent and electrolyte. Thus, the combination of the metal grid and the metal foil in the battery cell achieves concurrently the goals of low cost and good solvent and electrolyte flow. There is thus an improvement over cell structures utilizing metal grids throughout the cell with respect to cost, and there is an improvement over cells using metal foils throughout the cell with respect to solvent and electrolyte flow. These improvements apply to numerous cell structure configurations, as set forth in detail in the various embodiments of FIGS. 1A-8B. However, the improvement provided by the present invention is not limited to the particular configurations shown and described.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

1. A lithium polymer battery cell comprising:
a first electrode having at least one first electrode layer adjacent a first current collector;
a second electrode of opposite charge from the first electrode and having at least one second electrode layer adjacent a second current collector; and
a separator layer positioned between the first and second electrodes,
wherein one of the first and second current collectors is a metal grid and the other of the first and second current collectors is a metal foil.

2. The battery cell of claim 1 wherein the cell is a folded multicell in which the first electrode is configured continuously at the exterior of the multicell and the first current collector is the metal grid, and the second electrode is configured discontinuously at the interior of the multicell and the current collector is the metal foil.

3. The battery cell of claim 1 wherein the cell is a bicell comprising the second electrode sandwiched between a pair of first electrodes, with a pair of separator layers, one positioned between the second electrode and each of the pair of first electrodes.

4. The battery cell of claim 3 wherein second current collector is the metal foil and the first current collector in each of the pair of first electrodes is the metal grid.

5. The battery cell of claim 4 wherein the cell is a folded multibicell.

6. The battery cell of claim 4 wherein the pair of first electrodes is a pair of cathodes and the first current collector is an aluminum grid.

7. The battery cell of claim 4 wherein the second electrode is an anode and the second current collector is a copper foil.

8. The battery cell of claim 4 wherein the pair of first electrodes is a pair of anodes and the first current collector is a copper grid.

9. The battery cell of claim 4 wherein the second electrode is a cathode and the second current collector is an aluminum foil.

10. The battery cell of claim 3 wherein the second electrode comprises the second current collector sandwiched between a pair of second electrode layers, and wherein each of the pair of first electrodes comprises the first current collector positioned at the exterior of the bicell.

11. The battery cell of claim 3 wherein the second electrode comprises the second current collector sandwiched between a pair of second electrode layers, and wherein each of the pair of first electrodes comprises the first current collector sandwiched between a pair of first electrode layers.

12. The battery cell of claim 1 wherein first electrode comprises the first current collector sandwiched between a pair of first electrode layers.

13. The battery cell of claim 1 wherein the second electrode comprises the second current collector sandwiched between a pair of second electrode layers.

14. The battery cell of claim 1 wherein the first electrode comprises the first current collector positioned at the exterior of the battery cell.

15. The battery cell of claim 14 wherein the second electrode comprises the second current collector positioned at the exterior of the battery cell.

16. A lithium polymer battery bicell comprising:
a pair of anodes, each comprising a copper grid current collector adjacent at least one anode layer;
a cathode sandwiched between the pair of anodes and comprising an aluminum foil current collector sandwiched between a pair of cathode layers; and
a pair of separator layers, each positioned between the cathode and one of the pair of anodes.

17. The battery bicell of claim 16 wherein the pair of anodes each comprise a single anode layer and the current collector is positioned at the exterior of the battery cell.

18. The battery bicell of claim 16 wherein the pair of anodes each comprise the current collector sandwiched between a pair of anode layers.

19. The battery bicell of claim 16 wherein the pair of anodes are configured discontinuously and the bicell is in a folded configuration to form a corrugated multibicell.

20. A lithium polymer battery bicell comprising:
a pair of cathodes, each comprising an aluminum grid current collector adjacent at least one cathode layer;
an anode sandwiched between the pair of cathodes and comprising a copper foil current collector sandwiched between a pair of anode layers; and
a pair of separator layers, each positioned between the anode and one of the pair of cathodes.

21. The battery bicell of claim 20 wherein the pair of cathodes each comprise a single cathode layer and the current collector is positioned at the exterior of the battery cell.

22. The battery bicell of claim 20 wherein the pair of cathodes each comprise the current collector sandwiched between a pair of cathode layers.

23. The battery bicell of claim 20 wherein the pair of cathodes are configured discontinuously and the bicell is in a folded configuration to form a corrugated multibicell.
